(19) United States
(12) Patent Application Publication
(10) Pub. No.: US 2011/0232291 A1
(43) Pub. Date: Sep. 29, 2011

(54) SYSTEM AND METHOD FOR AN EXHAUST DIFFUSER

(75) Inventors: Jonathan Glenn Luedke, Simpsonville, SC (US); Jason Blue Star, Greenville, SC (US); Thomas Charles Billheimer, Atlanta, GA (US)

(73) Assignee: GENERAL ELECTRIC COMPANY, Schenectady, NY (US)

(21) Appl. No.: 12/732,468

(22) Filed: Mar. 26, 2010

(51) Int. Cl. F02K 1/00

(52) U.S. Cl. 60/771

(57) ABSTRACT

An exhaust diffuser includes a shroud and a wall radially separated from the shroud to define a fluid passage between the shroud and the wall. A strut extends between the shroud and the wall, and the strut includes a first surface having an adjustable camber. A method for adjusting air flow across a strut having a first side camber and a second side camber includes determining an incidence angle between the air flow and the strut and adjusting the first side camber of the strut.

### FIELD OF THE INVENTION

The present invention generally involves an exhaust diffuser for a gas turbine. More specifically, the present invention describes a system and method that adjusts the camber of a strut in the exhaust diffuser to improve the efficiency of the gas turbine.

### BACKGROUND OF THE INVENTION

Gas turbines are widely used in industrial and commercial operations. A typical gas turbine includes an axial compressor at the front, one or more combustors around the middle, and a turbine at the rear. The compressor includes multiple stages of rotating blades and stationary vanes. Ambient air enters the compressor, and the rotating blades and stationary vanes progressively impart kinetic energy to the working fluid (air) to bring it to a highly energized state. The working fluid exits the compressor and flows to the combustors where it mixes with fuel and ignites to generate combustion gases having a high temperature and pressure. The combustion gases exit the combustors and flow to the turbine where they expand to produce work. An exhaust diffuser downstream of the turbine converts the kinetic energy of the flow exiting the last stage of the turbine into potential energy in the form of increased static pressure. This is accomplished by conducting the flow through a duct of increasing area, during which the generation of total pressure loss is to be minimized. The exhaust diffuser typically includes one or more aerodynamic airfoils which surround structural struts that support the bearing.

Combustion gases enter the exhaust diffuser with a wide range of inlet swirl conditions across the load range of the gas turbine. The varying swirl conditions cause the combustion gases to intercept and flow over the struts at varying incidence angles, resulting in significant aerodynamic losses. In addition, high swirl at the inlet of the diffuser has the potential for causing mechanical excitation within the diffuser due to vortex shedding from the strut. Therefore, it is desirable to be able to adjust the diffuser struts according to existing swirl conditions of the combustion gases to enhance the aerodynamic performance of the gas turbine.

### BRIEF DESCRIPTION OF THE INVENTION

Aspects and advantages of the invention are set forth below in the following description, or may be obvious from the description, or may be learned through practice of the invention.

One embodiment of the present invention is an exhaust diffuser that includes a shroud and a wall radially separated from the shroud to define a fluid passage between the shroud and the wall. A strut extends between the shroud and the wall, and the strut includes a first surface having an adjustable camber.

Another embodiment of the present invention is an exhaust diffuser that includes a shroud and a wall radially separated from the shroud to define a fluid passage between the shroud and the wall. A strut extends between the shroud and the wall, and the strut includes a first side camber, a second side camber, and means for adjusting at least one of the first side camber or the second side camber.

The present invention also includes a method for adjusting air flow across a strut having a first side camber and a second side camber. The method includes determining an incidence angle between the air flow and the strut and adjusting the first side camber of the strut.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 shows a simplified cross-section of an exhaust diffuser according to one embodiment of the present invention;

FIG. 2 shows a cross-section of the exhaust diffuser shown in FIG. 1 taken along line 2-2;

FIG. 3 shows a simplified cross-section of a strut according to one embodiment of the present invention;

FIG. 4 shows a simplified cross-section of the strut shown in FIG. 3 for a particular incidence angle of the combustion gases;

FIG. 5 shows a simplified cross-section of a strut according to an alternate embodiment of the present invention; and

FIG. 6 shows a simplified cross-section of the strut shown in FIG. 5 for a particular incidence angle of the combustion gases.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide means for reducing aerodynamic losses across diffuser struts at high incidence angles. Embodiments of the present invention effectively add a small amount of camber near the leading edge of the strut to better align the leading edge of the strut with the incident flow of combustion gases. In the context of the present invention, the term “camber” refers to the amount of curvature in a surface. An inflatable bladder, hydraulic or pneumatic piston, threaded rod, or equivalent mechanical device may be used to create a bulge in the pressure side and reduce a bulge in the suction side of the strut to effectively bend the leading edge of the strut into the incident flow of combustion gases, reducing the pressure drop across the strut and axially aligning the flow of combustion gases. Benefits obtained by embodiments of the present invention may include improved diffuser aerodynamic performance in the presence of high swirl conditions and reduced vortex shedding due to high incidence angles which can lead to mechanical excitation problems.

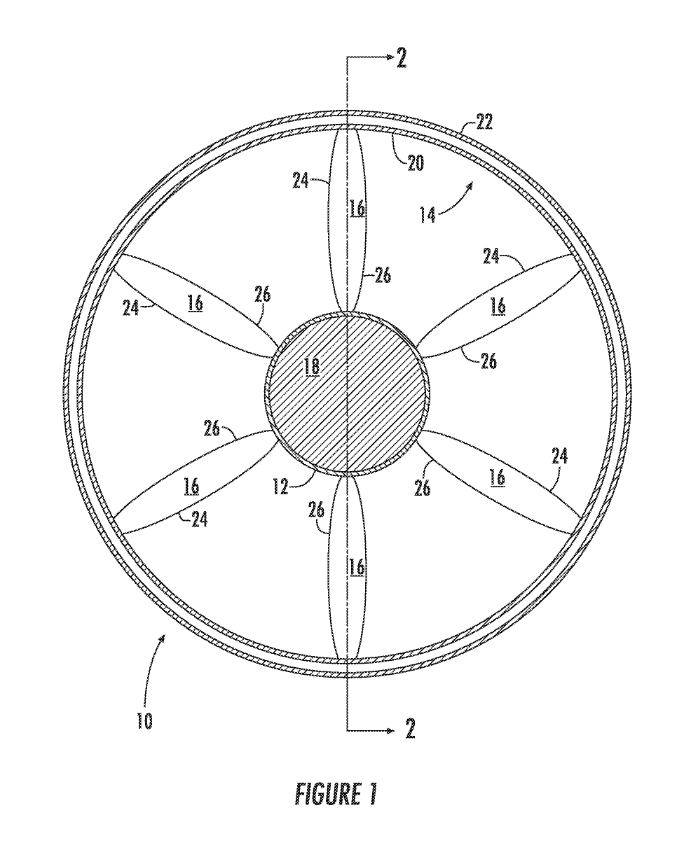

FIG. 1 shows a simplified cross-section of an exhaust diffuser 10 according to one embodiment of the present invention. As shown, the exhaust diffuser 10 generally includes a shroud 12, a wall 14, and one or more struts 16. The shroud 12 is generally an arcuate surface or casing that surrounds rotating components. For example as shown in FIG. 1, the shroud 12 may surround or encase a rotor 18 of a gas turbine. The wall 14 is radially separated from the shroud 12 and generally surrounds the shroud 12 to define a fluid passage between the shroud 12 and the wall 14. The wall 14 may be a double walled construction, with an inner wall 20 separated by an air space from an outer wall 22. The present invention is not limited to any particular size, shape, material, or other physical characteristics of the shroud 12 and/or wall 14, except as recited in the claims.

The struts 16 extend between the shroud 12 and the wall 14 to orient the wall 14 with respect to the shroud 12. In the context of the present invention, the term “strut” includes any structure or supporting member that extends between the shroud 12 and the wall 14. The struts 16 generally include a first surface 24 and a second surface 26 that combine to form an aerodynamic surface.

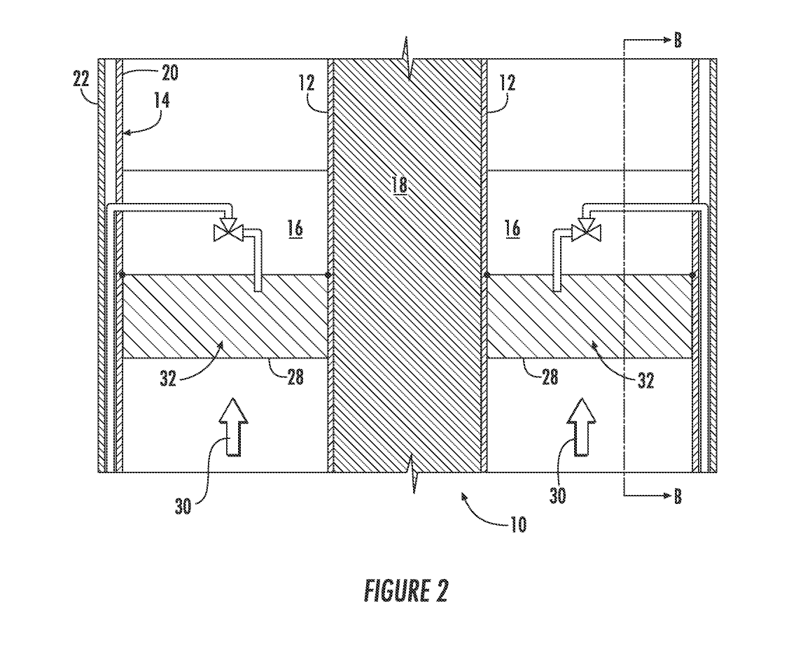

FIG. 2 shows a cross-section of the exhaust diffuser 10 shown in FIG. 1 taken along line 2-2. As shown in FIG. 2, each strut 16 includes a leading edge 28 facing the direction of the flow of combustion gases 30. Each strut 16 includes an adjustable surface or adjustable camber 32 that allows for the camber of one or both surfaces 24, 26 of the strut 16 to be adjusted. The adjustable surface or adjustable camber 32 may extend over a portion of the strut 16, as shown in FIG. 2. Alternately, the adjustable surface or adjustable camber 32 may extend over the entire length of the strut 16.

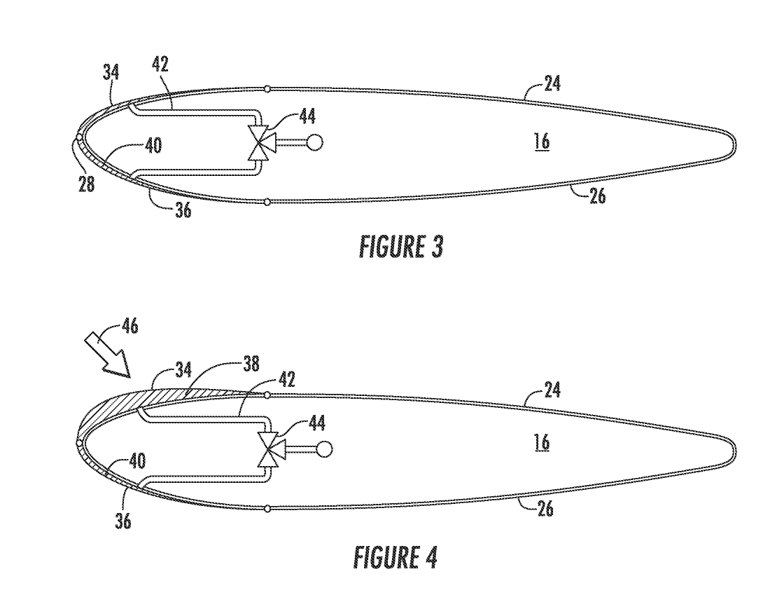

FIG. 3 shows a simplified cross-section of the strut 16, taken along B-B, according to one embodiment of the present invention. The first surface 24 and the second surface 26 of the strut 16 connect at the leading edge 28. The first and second surfaces 24, 26 of the strut 16 each have an associated camber 34, 36 that defines the airfoil or aerodynamic shape of the strut 16. As shown in FIG. 3, the strut 16 further includes means for adjusting at least one of the first side camber 34 or the second side camber 36. In this particular embodiment, the means includes a first side bladder 38 proximate to the first surface 24 and a second side bladder 40 proximate to the second surface 26. The bladders 38, 40 may be made of thin sheet metal, a para-aramid synthetic fiber such as DuPont's Kevlar®, austenitic nickel-chromium-based super alloys such as Huntington Alloys Corporation's Inconel®, stainless steel, or any other flexible material capable of withstanding temperatures of 1,200 degrees Fahrenheit or more. The size and length of the bladders 38, 40 may vary according to particular design needs and is not a limitation of the present invention, except as recited in the claims.

Pneumatic or hydraulic pressure may be directed to or from each bladder 38, 40 through tubing 42, piping, or similar structures to increase or decrease the pressure and thus the associated volume of each bladder 38, 40. For example, a three-way valve 44 may be used to increase the pressure in one bladder while simultaneously decreasing the pressure in the other bladder to change the camber of each surface 24, 26 of the strut. In alternate embodiments, a separate valve, port, or other flow control device may be used for each bladder to independently change the pressure in each bladder.

FIG. 4 shows the strut 16 shown in FIG. 3 for a particular direction of flow 46 of the combustion gases. As shown in FIG. 4, the means for adjusting at least one of the first side camber 34 or the second side camber 36 has directed fluid into the first side bladder 38 proximate the first surface 24 and out of the second side bladder 40 proximate the second surface 26. As a result, the first side bladder 38 proximate the first surface 24 increased in volume, producing a corresponding increase in the first side camber 34, and the second side bladder 40 proximate the second surface 26 decreased in volume, producing a corresponding decrease in the second side camber 36. In this manner, the strut 16 according to this embodiment of the present invention has adjusted the camber of the first and second side cambers 34, 36 to effectively reduce the incidence angle between the oncoming combustion gases 46 and the strut 16.

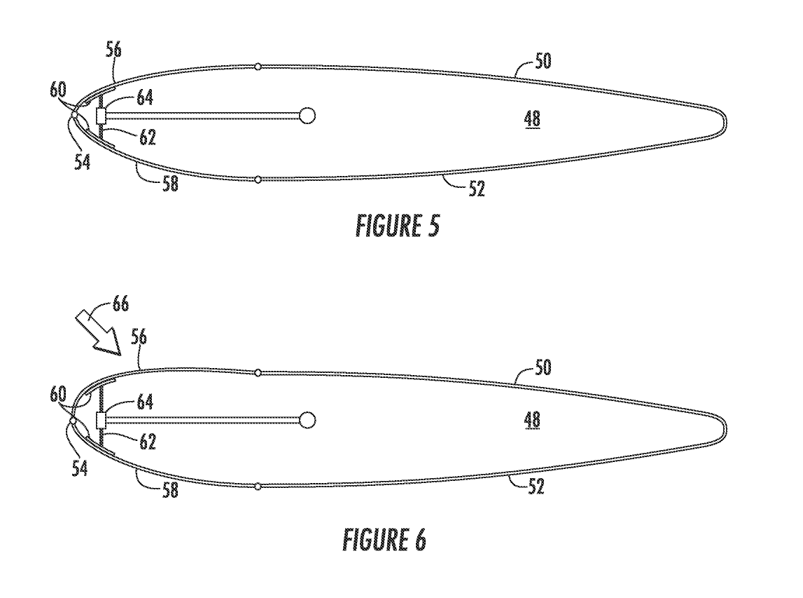

FIG. 5 shows a simplified cross-section of a strut 48 according to an alternate embodiment of the present invention. In this embodiment, the strut 48 again includes a first surface 50 and a second surface 52 that connect at a leading edge 54. The first and second surfaces 50, 52 of the strut 48 each have an associated adjustable camber 56, 58 that defines the airfoil or aerodynamic shape of the strut 48. In this embodiment, the means for adjusting the camber of at least one of the first or second surfaces includes one or more plates 60, a threaded rod 62, and a bolt 64. Each plate 60 is inside the strut 48 and proximate to each surface 50, 52 of the strut 48. Each plate 60 generally defines a shape corresponding to a desired camber for the strut 48 and is connected to an inside of each surface 50, 52 of the strut 48. The threaded rod 62 connects to each plate 60, and rotation of the bolt 64 determines the position for each plate 60. In this manner, rotation of the bolt 64 causes the threaded rod 62 to move toward one surface and away from the other. As a result, the camber of one surface of the strut 48 increases while the camber of the opposite surface decreases.

As shown in FIG. 6, the bolt 64 has been rotated to move the threaded rod 62 upward. As a result, the plate 60 proximate the first surface 50 of the strut 48 has increased the first side camber 56, and the plate 60 proximate the second surface 52 has decreased the second side camber 58. As a result, the leading edge 54 of the strut 48 has effectively been adjusted to reduce the incidence angle between the oncoming combustion gases 66 and the strut 48.

Numerous other means are known to one of ordinary skill in the art for moving the first and/or second surfaces to adjust the camber of the first and/or second surfaces of the strut. For example, various assemblies of hydraulic or pneumatic components, electrical motors, gears, or other mechanical devices may be used to change the shape of the first and/or second surfaces to produce the desired change in camber.

In operation, the exhaust diffuser having struts according to various embodiments of the present invention provides a method for adjusting air flow. The incidence angle between the flow of combustion gases and the strut can be determined through empirical observations or based on operating experience. For example, various instruments known in the art, including, but not limited to, pilot tubes and/or differential pressure detectors, may be used to determine the direction and velocity of the combustion gases. Alternately, prior operating experiences may be available to correlate current operating power levels with the direction and velocity of the combustion gases. Once the incidence angle is known, the camber for one or both surfaces of the strut may be adjusted to reduce the angle of incidence between the flow of the combustion gases and the leading edge of the struts. By reducing the angle of incidence between the flow of combustion gases and the leading edge of the struts, embodiments of the present invention reduce the flow resistance and resulting pressure drop across the struts. As a result, the present invention allows for larger variations and exit swirl of combustion gases while minimizing the negative effect on the thermodynamic efficiency of the gas turbine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An exhaust diffuser, comprising:
a. a shroud;
b. a wall radially separated from the shroud to define a fluid passage between the shroud and the wall;
c. a strut extending between the shroud and the wall, wherein the strut includes a first surface having an adjustable camber.

2. The exhaust diffuser as in claim 1, further including a bladder inside the strut and proximate the first surface.

3. The exhaust diffuser as in claim 1, further including a plate inside the strut and proximate the first surface.

4. The exhaust diffuser as in claim 1, further including a threaded rod inside the strut in operative engagement with the first surface.

5. The exhaust diffuser as in claim 1, wherein the strut includes a second surface having an adjustable camber.

6. The exhaust diffuser as in claim 5, wherein the strut includes means for adjusting the camber of at least one of the first surface or the second surface.

7. The exhaust diffuser as in claim 5, wherein the strut includes means for adjusting the camber of the first surface and the second surface.

8. The exhaust diffuser as in claim 5, wherein the strut includes means for simultaneously adjusting the camber of the first surface and the second surface.

9. An exhaust diffuser, comprising:
a. a shroud;
b. a wall radially separated from the shroud to define a fluid passage between the shroud and the wall;
c. a strut extending between the shroud and the wall, wherein the strut includes a first side camber and a second side camber; and
d. means for adjusting at least one of the first side camber or the second side camber.

10. The exhaust diffuser as in claim 9, wherein the means for adjusting at least one of the first side camber or the second side camber includes a bladder.

11. The exhaust diffuser as in claim 9, wherein the means for adjusting at least one of the first side camber or the second side camber includes an adjustable surface of the strut.

12. The exhaust diffuser as in claim 9, wherein the means for adjusting at least one of the first side camber or the second side camber is located in the strut.

13. The exhaust diffuser as in claim 9, further comprising means for adjusting the first side camber and the second side camber.

14. The exhaust diffuser as in claim 9, further comprising means for simultaneously adjusting the first side camber and the second side camber.

15. A method for adjusting air flow across a strut having a first side camber and a second side camber, comprising:
a. determining an incidence angle between the air flow and the strut; and
b. adjusting the first side camber of the strut.

16. The method as in claim 15, further including adjusting the second side camber of the strut.

17. The method as in claim 15, further including sensing the direction of air flow to determine the angle of attack between the air flow and the strut.

18. The method as in claim 15, further including sensing the air flow rate to determine the angle of attack between the air flow and the strut.

19. The method as in claim 15, further including increasing the first side camber.

20. The method as in claim 15, further including increasing the first side camber while decreasing the second side camber.
